(19) United States
(12) Patent Application Publication
(10) Pub. No.: US 2002/0118275 A1
(43) Pub. Date: Aug. 29, 2002

(54) Image conversion and encoding technique

(76) Inventor: Philip Victor Harman, Scarborough (AU)

Correspondence Address: Thomas L. McMasters, Fredrikson & Byron, P.A., 1100 International Center, 900 Second Avenue South, Minneapolis, MN, 55402, US

(21) Appl. No.: 09/921,649

(22) Filed: Aug. 3, 2001

(30) Foreign Application Priority Data
Aug. 4, 2000 (AU) PQ9222
Jan. 29, 2001 (AU) PR2757

(51) Int. Cl. H04N 13/00; H04N 15/00; H04N 13/04

(52) U.S. Cl. 348/51

(57) ABSTRACT

A method of producing left and right eye images for a stereoscopic display from a layered source including at least one layer, and at least one object on the at least one layer, including the steps of defining a depth characteristic for each object or layer and respectively displacing each object or layer by a determined amount in a lateral direction as a function of the depth characteristic of each layer.

### FIELD OF INVENTION

The present invention is directed towards a technique for converting 2D images into 3D, and in particular a method for converting 2D images which have been formed from a layered source.

### BACKGROUND

The limitation of bandwidth on transmissions is a well known problem, and many techniques have been attempted to enable the maximum amount of data to be transferred in the shortest time possible. The demands on bandwidth are particularly evident in the transmission of images, including computer generated images.

One attempt to address bandwidth and performance issues with computer generated images or animated scenes has been to only transfer changes in the image once the original scene has been transmitted. This technique takes advantage of the way in which cartoons have traditionally been created. That is, a cartoonist may create the perception of movement by creating a series of stills which contain all the intermediary steps which make up the movement to be created.

For simplicity and ease of amendment each object in an image will usually be created on a separate layer, and the layers combined to form the image. That is, a moving object would be drawn on a series of sheets so as to demonstrate movement of that object. However, no other objects or background would usually be drawn on that sheet. Rather, the background, which does not change, would be drawn on a separate sheet, and the sheets combined to create the image. Obviously, in some cases many sheets may be used to create a single still.

For cartoons or animated images which have been created using a series of different layers it is possible to save on data transmission by only transmitting those layers which have been altered. For example, if the background has not been changed there is no need to retransmit the background layer. Rather, the display medium can be told to maintain the existing background layer.

Along with the increase in the use of animated or computer generated images, there has also been an increase in the demand for stereoscopic images. The creation of stereoscopic images (at the filming stage) whilst viable, is significantly more costly, difficult and time consuming than 2D. Accordingly, the amount of stereo content in existence is lacking, and therefore there is a demand to be able to convert existing 2D images into 3D images.

Early attempts to convert 2D images into 3D images involved selecting an object within an image, and cutting and pasting that object in another location so as to create the effect of 3D. However, it was quickly discovered that this technique was unacceptable to either the public or the industry, as the technique by virtue of the cutting and pasting created “cut-out” areas in the image. That is, by cutting and moving objects, void areas without image data were created.

In order to provide a system to convert 2D images into 3D images, the present Applicants created a system whereby stereoscopic images are created from an original 2D image by:

a. identifying at least one object within the original image;

b. outlining each object;

c. defining a depth characteristic for each object; and

d. respectively displacing selected areas of each object by a determined amount in a lateral direction as a function of the depth characteristic of each object, to form two stretched images for viewing by the left and right eyes of the viewer.

This system disclosed in PCT/AU96/00820, the contents of which are incorporated herein by reference, avoided the creation of cut-out areas by stretching or distorting objects within the original image. That is, this prior system did not create the unacceptable problem of cut outs which simply moving an object creates.

Whilst the Applicants prior system may be utilised to convert 2D cartoons or animations, it is not ideal in some circumstances. For example, if a display system only receives alterations to the 2D image as opposed to the whole 2D image, the Applicants prior system would need to recreate the image so as to carry out the steps outlined above.

### OBJECTIVE OF THE INVENTION

It is therefore an objective of the present invention to provide an improved 2D to 3D conversion process which is applicable for use with layered 2D images such as cartoons, animations or other computer generated images, and including images created from a segmented source.

### SUMMARY OF THE INVENTION

With the above object in mind, the present invention provides in one aspect a method of producing left and right eye images for a stereoscopic display from a layered source including at least one layer, and at least one object on said at least one layer, including the steps of:

defining a depth characteristic for each object or layer, and

respectively displacing each object or layer by a determined amount in a lateral direction as a function of the depth characteristic of each layer.

The system may be modified to further segment objects into additional layers, and ideally the displaced objects would be further processed by stretching or distorting the image to enhance the 3D image.

The stored parameters for each object may be modified, for example an additional tag may be added which defines the depth characteristics. In such systems the tag information may also be used to assist in shifting the objects.

In order for the image to be compatible with existing 2D systems it may be desirable to process the 2D image at the transmission end, as opposed to the receiving end, and embed the information defining the depth characteristic for each object or layer in the 2D image, such that the receiver can then either display the original 2D image or alternatively the converted 3D image.

This system allows animated images and images generated from a layered source to be effectively and efficiently converted tor viewing in 3D. The additional data which is added to the image is relatively small compared with the size of the 2D image, yet enables the receiving end to project a 3D representation of the 2D image. In the preferred arrangement the system would ideally also allow the viewer to have some control over the 3D characteristics, such as strength and depth sensation etc.

### BRIEF DESCRIPTION OF THE DRAWINGS

To provide a better understanding of the present invention, reference is made to the accompanying drawings, which illustrate a preferred embodiment of the present invention.

In the Drawings

FIG. 1 shows an example composite layered 2D image.

FIG. 2 shows how the composite image in FIG. 1 may be composed of objects existing on separate layers.

FIG. 3 shows how left and right eye images are formed.

FIG. 4 shows a flow diagram of the process of the preferred embodiment of the present invention.

### DETAILED DESCRIPTION OF THE INVENTION

In the preferred embodiment, the conversion technique includes the following steps:

Identify Each Object on Each Layer and Assign a Depth Characteristic to Each Object

The process to be described is intended to be applied to 2D images that are derived from a layered source. Such images include, but are not limited to, cartoons, MPEG video sequences (in particular video images processed using MPEG4 where each object has been assigned a Video Object Plane) and Multimedia images intended for transmission via the Internet, for example images presented in Macromedia “Flash” format.

In such formats, the original objects on each layer may be vector representations of each object, and have tags associated with them. These tags may describe the properties of each object, for example, colour, position and texture.

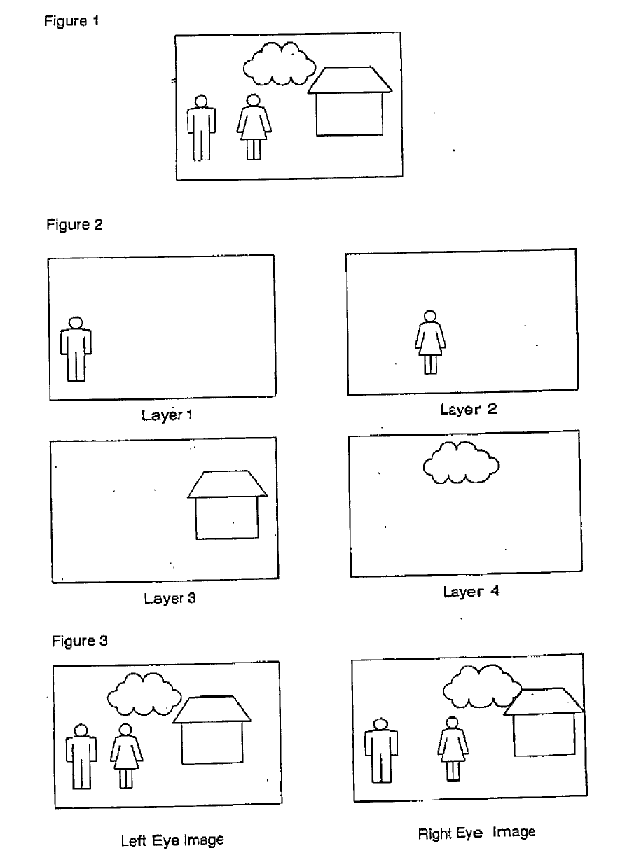

Such an example layered 2D image is shown in FIG. 1. FIG. 2 illustrates how the composite image in FIG. 1 can be composed of objects existing on separate layers and consolidated so as to form a single image. It will be appreciated by those skilled in the art that the separate layers forming the composite image may also be represented in a digital or video format. In particular it should be noted that the objects on such layers may be represented in a vector format, When necessary, objects in each layer of the 2D image to be converted may be identified by a human operator using visual inspection. The operator will typically tag each object, or group of objects, in the image using a computer mouse, light pen, stylus or other device and assign a unique number to the object, The number may be manually created by the operator or automatically generated in a particular sequence by a computer.

An operator may also use object identification information produced by another operator either working on the same sequence or from prior conversion of similar scenes.

Where more than one object is present on a specific layer it may be desirable to further segment the objects into additional layers to enhance the 3D effect. This is the case where a layer has multiple objects, and it is desired to have those objects at different depths. That is, if you have multiple objects on a single layer, and each needed to be at a different depth, then you would sub-segment the layer into one or more objects and/or layers.

In the preferred embodiment, each layer, and object within the layer, is assigned an identifier. In addition, each object is assigned a depth characteristic in the manner previously disclosed in application PCT/AU98/01005 that is hereby included by reference.

For vector representation an additional tag could be added to the vector representation to describe the object depth. The description could be some x meters away or have some complex depth, such as a linear ramp.

It should be noted that the tag describing the object depth need not describe the depth directly but represent some function of depth. Those skilled in the art would appreciate that such representations include, but are not limited to disparity and pull maps.

The depth of an object or objects may be determined either manually, automatically or semi-automatically. The depth of the objects may be assigned using any alphanumeric, visual, audible or tactile information. In another embodiment the depth of the object may be assigned a numerical value. This value may be positive or negative, in a linear or non-linear series and contain single or multiple digits. In a preferred embodiment this value will range from 0 to 255, to enable the value to be encoded in a single byte, where 255 represents objects that are to appear, once converted, at a 3D position closest to the viewer and 0 for objects that are at the furthest 3D distance from the viewer. Obviously this convention may be altered, eg reversed or another range used.

In manual depth definition the operator may assign the depth of the object or objects using a computer mouse, light pen, stylus or other device. The operator may assign the depth of the object by placing the pointing device within the object outline and entering a depth value. The depth may be entered by the operator as a numeric, alphanumeric or graphical value and may be assigned by the operator or automatically assigned by the computer from a predetermined range of allowable values. The operator may also select the object depth from a library or menu of allowable depths.

The operator may also assign a range of depths within an object or a depth range that varies with time, object location or motion or any combination of these factors. For example the object may be a table that ideally has its closest edge towards the viewer and its farthest edge away from the viewer. When converted into 3D the apparent depth of the table must vary along its length. In order to achieve this the operator may divide the table up into a number of segments or layers and assign each segment an individual depth. Alternatively the operator may assign a continuously variable depth within the object by shading the object such that the amount of shading represents the depth at that particular position of the table. In this example a light shading could represent a close object and dark shading a distant object. For the example of the table, the closest edge would be shaded lightly, with the shading getting progressively darker, until the furthest edge is reached.

The variation of depth within an object may be linear or non-linear and may vary with time, object location or motion or any combination of these factors.

The variation of depth within an object may be in the form of a ramp. A linear ramp would have a start point (A) and an end point (B). The colour at point A and B is defined. A gradient from Point A to Point 8 is applied on the perpendicular line.

A Radial Ramp defines a similar ramp to a linear ramp although it uses the distance from a centre point (A) to a radius (B). For example, the radial depth may be represented as:

x,y,r,d1, d2, fn

where x and y are the coordinates of the centre point of the radius, d1 is the depth at the centre, d2 is the depth at the radius and fn is a function that describes how the depth varies from d1 to d2, for example linear, quadratic etc.

A simple extension to the Radial Ramp would be to taper the outside rim, or to allow a variable sized centre point.

A Linear Extension is the distance from a line segment as opposed to the distance from the perpendicular. In this example the colour is defined for the line segment, and the colour for the “outside”. The colour along the line segment is defined, and the colour tapers out to the “outside” colour.

A variety of ramps can be easily encoded. Ramps may also be based on more complex curves, equations, variable transparency etc.

In another example an object may move from the front of the image to the rear over a period of frames. The operator could assign a depth for the object in the first frame and depth of the object in the last or subsequent scene. The computer may then interpolate the depth of the object over successive frames in a linear or other predetermined manner. This process may also be fully automated whereby a computer assigns the variation in object depth based upon the change in size of an object as it moves over time.

Once an object has been assigned a specific depth the object may then be tracked either manually, automatically or semi-automatically as it moves within the image over successive frames. For example, if an object was moving or shifting though an image over time, we could monitor this movement using the vector representations of the object. That is, we could monitor the size of the vectors over time and determine if the object was getting larger or smaller. Generally speaking if the object is getting larger then it is probably getting closer to the viewer and vise versa. In many cases the object will be the only object on a particular layer.

An operator may also use depth definitions produced by another operator either working on the same sequence or from prior conversion of similar scenes.

In order to produce more realistic looking 3D it is sometimes desirable to utilise depth definitions that are more complex than simple ramps or linear variations. This is particularly desirable for objects that have a complex internal structure with many variations in depth, for example, a tree. The depth map for such objects could be produced by adding a texture bump map to the object. For example, if we consider a tree, we would firstly assign the tree a depth. Then a texture bump map could be added to give each leaf on the tree its own individual depth. Such texture maps have been found useful to the present invention for adding detail to relatively simple objects.

However, for fine detail, such as the leaves on a tree or other complex objects, this method is not preferred, as the method would be further complicated should the tree, or the like, move in the wind or the camera angle change from frame to frame. A further and more preferred method is to use the luminance (or black and white components) of the original object to create the necessary bump map. In general, elements of the object that are closer to the viewer will be lighter and those further away darker. Thus by assigning a light luminance value to close elements and dark luminance to distant elements a bump map can be automatically created. The advantage of this technique is that the object itself can be used to create its own bump map and any movement of the object from frame to frame is automatically tracked. Other attributes of an object may also be used to create a bump map, these include but are not limited to, chrominance, saturation, colour grouping, reflections, shadows, focus, sharpness etc.

The bump map values obtained from the object attributes will also preferably be scaled so the that the range of depth variation within the object are consistent with the general range of depths of the overall image.

Each layer, and each object is assigned an identifier, and further each object is assigned a depth characteristic. The general format of the object definition is therefore:

<layer identifier><object identifier><depth characteristic>

where each identifier can be any alphanumeric identifier and the depth characteristic is as previously disclosed. It should be noted that the depth characteristic may include alphanumeric representations of the object's depth.

The present invention discloses the addition of a depth characteristic identifier to existing layer based image storage and transmission protocols that may already identify objects within an image by other means.

In the simplest implementation the layer identifier may be used as a direct, or referred, reference to the object depth.

For example purposes only, consider a 2D image consisting of 4 layers with each layer containing a single object. The layers may be numbered 1 to 4 and ordered such that, when displayed stereoscopically, the object on layer 1 appears closest to the viewer, the object on layer 2 appears behind the object on layer 1 etc, such that the object on layer 4 appears furthest from the viewer. It will be obvious to those skilled in the art that this sequence could be reversed i.e. layer 4 could contain an object that is closer to the viewer and layer 1 an object furthest from the viewer or a non sequential depth or non linear representations applied.

This technique of allocating the layer number as the depth value, is suited for relatively simple images where the number of objects, layers and relative depths does not change over the duration of the image.

However, this embodiment has the disadvantage that should additional layers be introduced or removed during the 2D sequence then the overall depth of the image may vary between scenes. Accordingly, the general form of the object definition overcomes this limitation by separating the identifiers relating to object depth and layer.

Laterally Displace Each Layer

For purpose of explanation only it is assumed that the 2D image is composed of a number of objects that exist on separate layers. It is also assumed that the 2D image is to be converted to 3D and displayed on a stereoscopic display that requires separate left and right eye images. The layers are sequenced such that the object on layer 1 is required to be seen closest to the viewer when converted into a stereoscopic image and the object on layer n furthest from the viewer.

For purpose of explanation only, it is also assumed that the object depth is equal to, or a function of, the layer number. It is also assumed that the nearest object i.e. layer 1, will have zero parallax on the stereoscopic viewing device such that the object appears on the surface of the display device, and that all other objects on sequential layers will appear behind successive objects.

In order to produce the left eye image sequence a copy of layer 1 of the 2D image is made. A copy of layer 2 is then made and placed below layer 1 with a lateral shift to the left. The amount of lateral shift is determined so as to produce an aesthetically pleasing stereoscopic effect or in compliance with some previously agreed standard, convention or instruction. Copies of subsequent layers are made in a similar manner, each with the same lateral shift as the previous layer or an increasing lateral shift as each layer is added. The amount of lateral shift will determine how far the object is from the viewer. The object identification indicates which object to shift and the assigned depth indicates by how much.

In order to produce the right eye image sequence a copy of layer 1 of the 2D image is made. A copy of layer 2 is then made and placed below layer 1 with a lateral shift to the right. In the preferred embodiment the lateral shift is equal and opposite to that used in the left eye. For example, should layer 2 be shifted to the left by −2 mm then for the right eye a shift of +2 mm would be used. It should be appreciated that the unit of shift measurement will relate to the medium the 2D image is represented in and may include, although not limited to, pixels, percentage of image size, percentage of screen size etc.

A composite image is then created from the separate layers so as to form separate left and right eye images that may subsequently be viewed as a stereo pair. This is illustrated in FIG. 3.

In the preceding explanation it is possible that the original layered image may be used to create one eye view as an alterative to making a copy. That is, the original image may become the right eye image, and the left eye image may be created by displacing the respective layers.

It will be understood by those skilled in the art that this technique could be applied to a sequence of images and for explanation purposes only a single 2D image has been illustrated.

It will also be understood by those skilled in the art that the objects in the original 2D image may be described in other than visible images, for example vector based representations of objects. It is a specific objective of this invention that it be applicable to all image formats that are composed of layers. This includes, but is not limited to, cartoons, vector based images i.e. Macromedia Flash, MPEG encoded images (in particular MPEG 4 and MPEG 7 format images) and sprite based images.

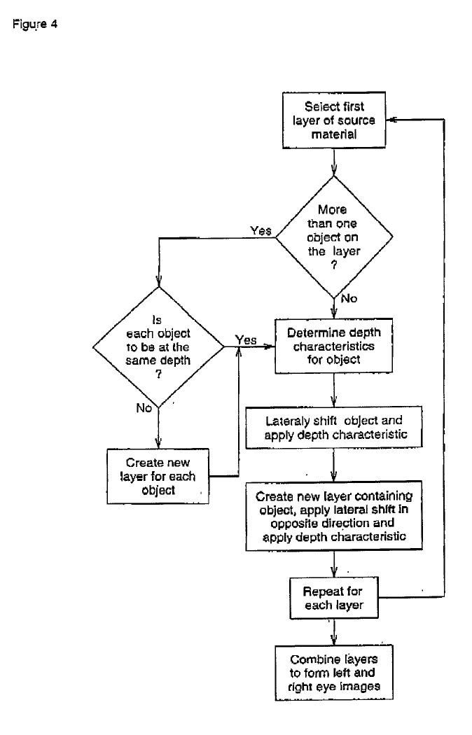

Referring now to FIG. 4 there is shown a flow diagram of the preferred embodiment of the present invention. After receiving an image from a layered source, the system selects the first layer of the source material. It will be understood, that whilst an object may be located on a separate layer in some instances multiple objects may be located on the same layer. For example a layer which serves merely as a background may in fact have a number of objects located on that layer. Accordingly, the layer is analyzed to determine whether or not a plurality of objects are present on that layer.

If the layer does have multiple objects, then it is necessary to determine whether each of those objects on that layer are to appear at the same depth as each other object on that layer. If it is desired that at least one of the objects on the layer appears at a different depth to another object on that same layer then a new layer should be created for this object. Similarly, if a number of the objects on a single layer are each to appear at different depths, then a layer for each depth should be created. In this way a layer will only contain a single object, or multiple objects which are to appear at the same depth.

Once a single object layer, or a layer with multiple objects which are to appear at the same depth has been determined, and it is necessary to assign a depth to those objects. This depth may be assigned manually by an operator or by some other means such as predefined rule set. Once the objects on the layer have been assigned a depth characteristic, it is necessary to then modify the objects and/or layers to create a stereoscopic image.

The stereoscopic image will include both a left eye image and a right eye image. The system may conveniently create the left eye image first by laterally shifting the layer as a function of the depth characteristic. Alternatively, for electronic versions of the image, it may be simpler to laterally shift the object or objects that is on the layer. For example, considering an electronic version such as Flash, then the object could be shifted by adjusting the tags associated with that object. That is, one of the object tags would be the x, y coordinate. This system may be configured to modify these x, y coordinates as a function of the depth characteristic of the object so as to laterally shift the object. By laterally shifting the object and/or layer, the left eye image may be created.

In order to create the right eye image a new layer is created, and the original object and/or layer, that is before any lateral shifting is carried out to create the left eye image, is then laterally shifted in the opposite direction to that used to create the left eye. For example if the object for the left eye was laterally shifted 2 millimeters to the left, then the same object would be laterally shifted 2 millimeters to the right for the right eye image. In this way, the right eye image is created. Once the left and right eye images are created for the object or objects on the layer, the system then selects the next layer of the image and follows the same process. It will be obvious, that rather than select the first layer this system could equally chose the last layer to process initially.

Once each layer has been processed as above, it is then necessary to combine the respective layers to form the left and right eye images. These combined layers can then be viewed by a viewer on a suitable display.

It is envisaged that the analysis process will be determined, and data embedded into the original 2D image prior to transmission. This data would include the information required by the display system in order to produce the stereoscopic images. In this way, the original image may be transmitted, and viewed in 2D or 3D. That is, standard display systems would be able to receive and process the original 2D image and 3D capable displays would also be able to receive the same transmission and display the stereoscopic images. The additional data embedded in the 2D image may essentially be a data file which contains the data necessary to shift each of the objects and/or layers or alternatively may actually be additional tags associated with each object.

In some applications the mere lateral shift of an object may result in a object that has a flat and “cardboard cut-ouf” look to it. This appearance is acceptable in some applications, for example animation and cartoon characters. However, in some applications it is preferable to further process the image or objects by using the stretching techniques previously disclosed as well as the lateral shift. That is, not only are the objects and/or layers laterally shifted as a function of the depth characteristic assigned to the object, but preferably the object is also stretched using the techniques disclosed in PCT/AU96/00820.

In a more practical sense, and considering for example a Flash animation file comprising four layers, Layer 1, Layer 2, Layer 3 and Layer 4 as shown in FIG. 1. The operator would load the file into the Macromedia Flash software. The objects shown in FIG. 2 exist on the respective layers. In a preferred embodiment the operator would click with a mouse on each object, for example the “person” on Layer 1. The software would then open a menu that would allow the operator to select a depth characteristic for the object. The menu would include simple selections such as absolute or relative depth from the viewer and complex depths. For example the menu may include a predetermined bump map for an object type “person” that, along with the depth selected by the operator, would be applied to the object. After selecting the depth characteristics the software would create a new layer, Layer 5 in this example, and copy the “person” with the necessary lateral shifts and stretching onto this new layer. The original Layer 1 would also be modified to have the necessary lateral shifts and stretching. This procedure would be repeated for each object on each layer which would result in additional layers 6, 7 and 8 being created. Layers 1 to 4 would then be composited to form for example the left eye image and layers 5 to 8 the right eye.

It should be noted that currently available Macromedia Flash software does not support the facility to assign a depth characteristic to an object and the functionality has been proposed for illustrative purposes only.

Where each object has been assigned a separate layer, and a simple lateral shift is to be applied, then the process may be automated. For example the operator may assign a depth for the object on Layer 1 and the object on layer n. The operator would then describe the manner in which the depth varied between the first and nth layer. The manner will include, although not limited to, linear, logarithmic, exponential etc. The software would then automatically create the new layers and make the necessary modification to the existing objects on the original layers.

It should be noted that both manual and automatic processing may be used. For example, automatic processing could be used for layers 1 to 4, manual on layer 5, and automatic on layers 6 to n.

Encoding and Compression

In some circumstances there can be a significant redundancy in the allocation of depth to objects. For example, should an object appear at the same x, y co-ordinates and at the same depth in subsequent image frames then it is only necessary to record or transmit this information for the first appearance of the object.

Those skilled in the art will be familiar with techniques to encode and compress redundant data of this nature.

Alternative Embodiments

It will be appreciated that the lateral displacement technique can only be applied where objects on underlying layers are fully described. Where this is not the case, for example where the 2D image did not originally exist in layered form, then the previously disclosed stretching techniques can be applied to create the stereoscopic images. In this regard it is noted that simply cutting and pasting an object, is not commercially acceptable and therefore some stretching technique would be required. Alternatively, the non-layered 2D source may be converted into a layered source using image segmentation techniques. In such circumstances the present invention will then be applicable.

By simply laterally shifting objects the resulting 3D image may contain objects that appear to be flat or have a “cardboard cutout” characteristic. In some embodiments this may make the 3D images look flat and unreal. However, for some applications this may be preferred. Cartoons, for example, produce favourable results. Whilst a 3D effect can be created this may not be optimum in some situations. Thus, if it is desired to give the objects more body then the objects and/or layers may be further processed by applying the present Applicants previously disclosed stretching techniques so that the 3D effect may be enhanced. For example, an object may have a depth characteristic that combines a lateral shift and a depth ramp. The resulting object would therefore be both laterally displaced as disclosed in the present invention and stretched as disclosed in PCT/AU96/00820.

Where objects do exist in a layered from, and are partially or fully described, the stretching technique is not required to identify and outline objects since this has already been undertaken. However, the allocation of depth characteristics is stiff required.

It will be known to those skilled in the art that stereoscopic displays are emerging that do not rely on left eye and right eye images as a basis of their operation. It is the intention of this invention that the techniques described may be employed by existing and future display technologies.

For example, displays are emerging that require a 2D image plus an associated depth map. In this case the 2D image of each object may be converted into a depth map by applying the depth characteristics identifier previously described to each object.

The individual layers then be superimposed to form a single image that represents the depth map for the associated 2D image. It will be appreciated by those skilled in the art that this process can be applied either prior to displaying the stereoscopic images or in real time.

In addition, another display type is emerging that requires more images than simply a stereo pair. For example, the autostereoscopic LCD display manufactured by Phillips requires 7 or 9 discrete images where each adjacent image pair consist of a stereo pair. It will be appreciated that the lateral displacement technique described above may also be used to create multiple stereo pairs suitable for such displays. For example, to create an image sequence suitable for an autostereoscopic display requiring 7 views the original 2D image would be used for the central view 4 and views 1 to 3 obtained by successive lateral shifts to the left. Views 5 to 7 would be formed from successive lateral shifts to the right.

As we have previously disclosed, the depth characteristics may be included in the definition of the original 2D image thus creating a 2D compatible 3D image. Given the small size of this data, 2D compatibility is obtained with minimal overhead.

We have also previously disclosed that the depth characteristics can be included in the original 2D images or stored or transmitted separately.

Whilst the present invention has disclosed a system for converting 2D images from a layered source, it will be understood that modifications and variations such as would be apparent to a skilled addressee are considered within the scope of the present invention.

The claims defining the invention are as follows

1. A method of producing left and right eye images for a stereoscopic display from a layered source including at least one layer, and at least one object on said at least one layer, including the steps of:
defining a depth characteristic for each object or layer, and respectively displacing each object or layer by a determined amount in a lateral direction as a function of the depth characteristic of each layer.

2. A method as claimed in claim 1, wherein at least one said layer having a plurality of said objects is segmented into additional layers.

3. A method as claimed in claim 2, wherein an additional layer is created for each said object.

4. A method as claimed in claim 1, wherein at least one said object is stretched to enhance the stereoscopic image.

5. A method as claimed in claim 1, wherein a tag associated with each said object includes the depth characteristics for said object.

6. A method as claimed in claim 1, wherein each object and layer is assigned an identifier and/or a depth characteristic.

7. A method as claimed in claim 7, wherein object identification may be defined as <layer identifier> <object identifier> <depth characteristic>.

8. A method as claimed in claim 8, wherein each identifier is an alphanumeric identifier.

9. A method as claimed in claim 7, wherein said layer identifier is a reference to said depth characteristic.

10. A system for transmitting stereoscopic images produced using a method as claimed in claim 1, wherein depth characteristics for each said object or layer is embedded in said layered source.

11. A method of producing left and right eye images for a stereoscopic display from a layered source including at least one layer, and at least one object on said at least one layer, including the steps of:
duplicating each said layer to create said left and right eye images;
defining a depth characteristic for each object or layer, and respectively displacing each object or layer by a determined amount in a lateral direction as a function of the depth characteristic of each layer.

12. A method as claimed in claim 11, wherein said displacing of said left and right eye images is in an equal and opposite direction.
